(19) United States
(12) Patent Application Publication
(10) Pub. No.: US 2015/0286720 A1
(43) Pub. Date: Oct. 8, 2015

(54) METHODS AND SYSTEMS FOR COLLECTING, MANAGING, AND SHARING DATA

(71) Applicants: Christopher J. Walsh, South Jordan, UT (US); Robert L. Selfridge, Philipsburg, PA (US)

(72) Inventors: Christopher J. Walsh, South Jordan, UT (US); Robert L. Selfridge, Philipsburg, PA (US)

(73) Assignee: TMM DATA, LLC, Philipsburg, PA (US)

(21) Appl. No.: 13/704,211

(22) PCT Filed: Dec. 11, 2012
(86) PCT No.: PCT/US12/68999

§ 371 Date: Dec. 13, 2012

(51) Int. Cl. G06F 17/30

(52) U.S. Cl. CPC G06F 17/30861; G06F 17/30082; G06F 17/30595

(57) ABSTRACT

Systems and methods for collecting, managing and sharing date include a server computer system that receives a data set containing flat data from a client computer system. The server computer system generates a relational database from the flat data and provides, through a web-based interface, user options for modifying the relational database, as well as application programming interfaces configured to provide data of the relational database to third parties. In accordance with another implementation of the invention, a client computer system sends flat data to a server computer system, causing the server computer system to generate a relational database from flat data. The client computer system receives and displays a web-based user interface that identifies fields of the flat data as part of the relational database, along with user options for modifying the fields of the relational database.

### CROSS-REFERENCE TO RELATED APPLICATIONS

The present application is a 371 U.S. National Stage of PCT Patent Application No. PCT/US12/68999, filed Dec. 11, 2012, entitled “Methods and Systems for Collecting, Managing, and Sharing Data,” the entire content of which is incorporated herein by reference.

### BACKGROUND OF THE INVENTION

1. The Field of the Invention

The present invention relates generally to data collection, management, and sharing.

2. Background and Relevant Art

Data collection, management, and sharing are ubiquitous in our society and in the information age. Many individuals and organizations create, consume, and maintain vast quantities of data—they have data in spreadsheets, textual documents, databases, enterprise systems, third-party systems, etc. As such, individuals and organizations face the challenge of sharing data across platforms and maintaining datasets.

For example, many individuals and organizations use relatively simple tools such as text documents, spreadsheets, and email to manually enter, organize, store, and share datasets. Using manual means to enter and maintain data is subject to human error and inconsistency. As such, datasets can become disjointed and error-prone as human interaction with the datasets increase in number and iteration.

Referring specifically to data entry, for example, data entry by humans is prone to causing data discrepancies. Different front-end client users—or even the same client user from one data entry to the next—may provide discrepant data. Data discrepancies may result from various expressions of the same piece of information. For example, United States of America, United States, U.S.A., and U.S. are all commonly used terms identifying the same country. Furthermore, different users may interpret the type of data that is requested or required by a particular data field in different ways. Discrepancies like the foregoing complicate the process of standardizing, managing, and sharing data.

Additionally, different users often have different interests, needs, and knowledge related to the same data entity. As such, different users may provide different, but related information, for the data entity. For example, a marketing team for a product may have three different team members: one who focuses on social media advertising, a second focused on search advertising, and a third focused on display advertising. Although all three members may provide information related to the same data entity (the product), they may provide different types of information.

For example, the social media advertising member may enter social media website data, the search advertising member may enter data related to search engines. Meanwhile, the display advertising member may enter a set of data that is both different from, yet overlapping with, data entered by the other two members. When multiple users provide information related to different aspects of the same data entity, the differences among various data entries often compromises the user experience when interfacing with the data, and may also compromise the integrity of the data itself.

Referring to database management, multiple users providing different information related to the same data entity often complicates the integration and standardization of the data, making it difficult to retrieve and share the data. In addition, multiple users providing different information related to the same data entity often makes it difficult and burdensome to provide a data set that complies with numerous protocols and standards used to achieve efficient database management.

With conventional methods for data creation, management and sharing, users often face a spreadsheet vs. database dilemma. On one hand, many individuals and organizations use spreadsheet and text documents for data creation, management and sharing because they are accessible to non-technical users. The accessibility of spreadsheets comes at costs, however. For example, data management and sharing with spreadsheets and text documents are labor-intensive and error-prone. Moreover, spreadsheets and text documents are sometimes ineffective for organizing, cross referencing, retrieving, standardizing, customizing, transforming and querying complex data. Such operations are typically better suited for relational databases, object-oriented databases, document-oriented databases, or some other types of databases.

On the other hand of the spreadsheet vs. database dilemma is the cost and technical difficulty of conventional database implementations. Conventional database management systems and database programing languages (SQL, XML, OQL, etc.) are powerful tools for managing complex data. The optimal use of such tools, however, often requires internal developers or outside IT consultants to write custom scripts or custom codes to take a dataset, manipulate the dataset and then share data for downstream use. As such, many individuals and organizations do not have or cannot afford the technical expertise or resources for effective database management.

Moreover, even for those users who have the resources and technical expertise of database management, inter-system inoperability poses a technical challenge. For example, different database management systems may use different database languages, causing inter-system inoperability. Even within the same database language, different implementations of database management systems may have different database schema, data structure, and/or format.

For example, lack of full compliance with, and different interpretations of, the SQL standard often cause SQL code portability problems between major relational database management system products. In addition, the large size and incomplete specification of the SQL standard, as well as vendor intentional lock-in, can also aggravate interoperability even within the same database language, such as SQL. Therefore, it may be difficult to share data across different database management systems or among users who require different data formats and structures.

Accordingly, there are a number of disadvantages in the art of data collection and management that can be addressed.

### BRIEF SUMMARY OF THE INVENTION

Implementations of the present invention overcome one or more problems in the art with systems, methods, and apparatus configured to collect, manage, and share data. In at least one implementation, for example, a system can provide customized user interfaces that simplify the process of data gathering and data entering for multiple users. The system can also provide means to more easily integrate, standardize, and manage data. Furthermore, the system can be configured to easily share data across different database management systems that have different database languages, data structure, or data format.

In one or more implementations, a method for automatically generating a relational database includes receiving, at a web-based interface, a data set from a client computer system. The data set comprises flat data having data field(s). Based on based on receiving the data set, the computer system automatically identifies the data field(s) from the flat data, and generates a relational database comprising each identified data field from the flat data. The computer system stores the relational database for subsequent modification, management, and/or retrieval by users at client computer systems. The computer system also provides, through the web-based interface, user options for modifying the identified data fields of the relational database as well as application programming interfaces (APIs) configured to provide one or more of the identified data fields of the relational database to one or more third parties.

In one or more additional implementations, a method for automatically generating a database based on flat data sent by a user includes a client computer system sending user input of a data set to a server computer system. The data set comprises flat data having field(s). The user input causes the server computer system to automatically generate a relational database from the field(s) of the flat data. The client computer system displays a web-based user interface received from the server computer system. The web-based user interface then identifies the field(s) from the flat data as part of the relational database. The client computer system also displays, through the web-based user interface, user options for modifying the field(s) of the relational database. The client computer system sends to the server computer system user inputs modifying the fields of the relational database.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is an architectural diagram depicting a computer architecture for collecting, managing, and sharing data, according to one or more implementations of the invention;

FIG. 2 is a flowchart of a method, according to one or more implementations of the invention, for automatically generating a relational database based on flat data received from a client computer system; and

FIG. 3 is a flowchart of a method, according to one or more implementations of the invention, for automatically generating a database based on flat data sent by a user.

### DETAILED DESCRIPTION OF THE PREFERRED EMBODIMENTS

Implementations of the present invention provide systems, methods, and apparatus configured to collect, manage, and share data. In at least one implementation, for example, a system can provide customized user interfaces that simplify the process of data gathering and data entering for multiple users. The system can also provide means to more easily integrate, standardize, and manage data. Furthermore, the system can be configured to easily share data across different database management systems that have different database languages, data structure, or data format.

For example, implementations of the present invention provide a middleware system that receives data, converts data, and enables access to data. More particularly, implementations of the present invention receive data in convenient flat formats (e.g., spreadsheets, text files, etc.) and convert that data to more powerful relational formats, while also providing normalization of the data Implementations also provide tools for editing and otherwise manipulating the data, once it is received, and for creating customized forms for enabling end-users to work with the data. Implementations also provide for third-party access to the data through customizable Application Programming Interfaces (APIs). As such, implementations of the invention provide users rich tools for entering, manipulating, and sharing data while easing the burden of data administration and management.

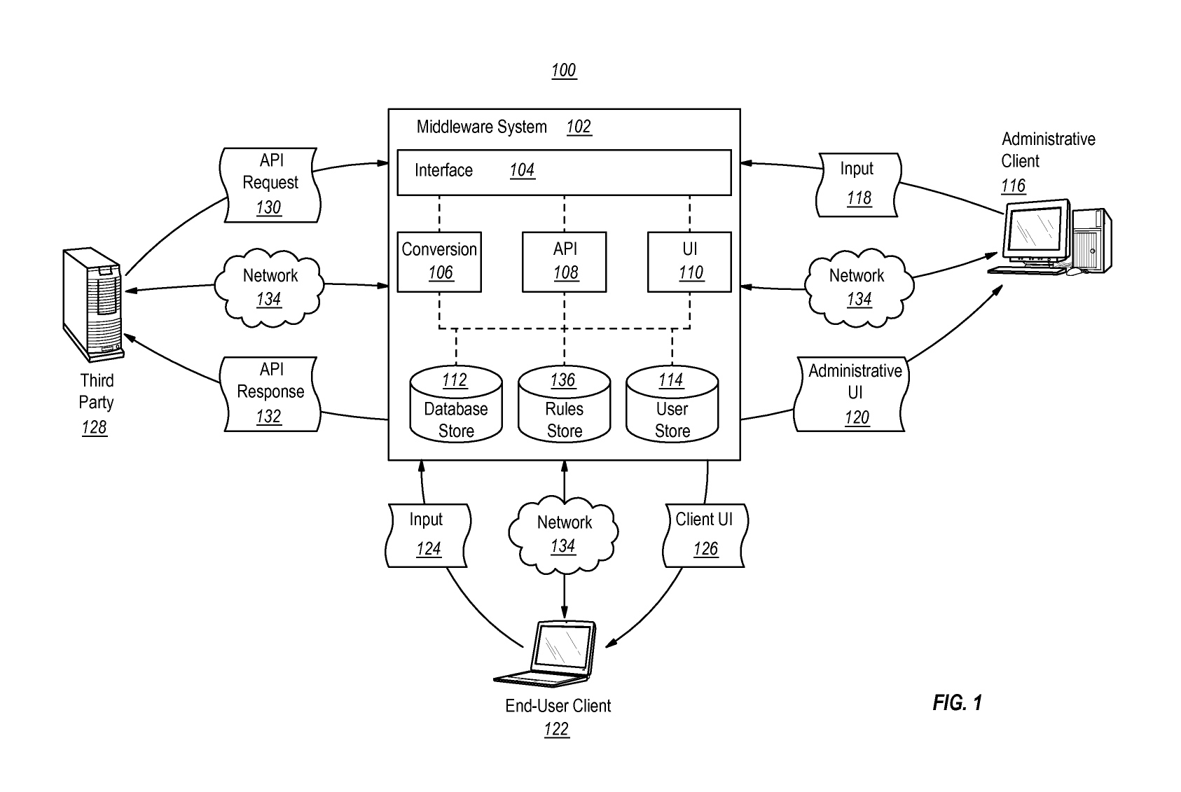

FIG. 1 illustrates an example computer architecture 100 for collecting, managing, and sharing data, according to one or more implementations of the invention. As depicted in FIG. 1, computer architecture 100 includes middleware system 102. Computer architecture 100 can also include one or more of administrative client 116, end-user client 122, or third party 128. While only a single administrative client, end-user client, and third party have been depicted, computer architecture 100 may include multiple of each entity.

Additionally or alternatively, computer architecture 100 can include a single entity that embodies two or more of the foregoing (e.g., a single computer system that functions as two or more of an administrative client, an end-user client, and a third party). In some implementations, administrative client 116 comprises a client computer system from which an administrative user has logged-in to middleware system 102, while end-user client 122 comprises a client computer system from which an end-user has logged-in to middleware system 102. As such, a single client computer system can be an administrative client or an end-user client, depending on the type of user accessing middleware system 102 from the client computer system.

As depicted, middleware system 102, administrative client 116, end-user client 122, and third party 128 can be connected via network 134. Network 134 can comprise any appropriate network communications mechanism, such as local loopback communications, one or more Local Area Networks, one or more Wide Area Networks, the Internet, etc., or combinations thereof. Network 134 may comprise a single network, or a plurality of different networks.

As depicted, middleware system 102 can include a plurality of modules/components for collecting, managing, and sharing data. For example, middleware system 102 can include the depicted interface module 104, conversion module 106, application programming interface (API) module 108, user-interface (UI) module 110, database store 112, user store 114, and rules store 136. The depicted modules/components can be implemented as software, as computer hardware, and as combinations of software and hardware. As depicted, each module/component can be interconnected, as appropriate, to communicate with one another. One of skill in the art will recognize, after reviewing this disclosure, that the functionality of middleware system 102 can be implemented with a variety of module/component configurations. As such, the principles described herein are not limited to the depicted number, type, and arrangement of modules/components.

In at least one implementation, interface module 104 is configured to communicate with computer systems that are interconnected with middleware system 102 (e.g., the depicted third party 128, end-user client 122, and/or administrative client 116). Interface module 104 can communicate with other computer systems using any appropriate communications protocol, such as File Transfer Protocol (FTP), Post Office Protocol (POP), Internet Message Access Protocol (IMAP), Hypertext Transfer Protocol (HTTP), HTTP secure (HTTPS), etc. In some implementations, interface module 104 comprises a web-based interface, such as an HTTP/HTTPS server (e.g., IIS, Apache, etc.).

In at least one implementation, conversion module 106 is configured to receive input data from administrative client 116 and/or end-user client 122, and to store that input data in database store 112 as one or more data structures. In doing so, conversion module 106 may apply a variety of conversions to the input data. For example, conversion module 106 may be configured to receive flat data (e.g., a flat data file such as a spreadsheet, a text document containing tab- or comma-delimited values, an XML document, etc.) and to automatically convert the flat data into relational data stored in a relational data structure.

When converting flat data to relational data, conversion module 106 can identify data fields and data types in the flat data, and identify relationships between data fields. Conversion module 106 can then generate relational data tables based on the identified data fields. In addition, conversion module 106 can generate unique identifiers for identified data fields and/or generated data tables, and then form data relationships through the generated unique identifiers. By converting flat data to relational data, conversion module 106 can enable individuals and organizations to combine the simplicity and accessibility of flat data (e.g., spreadsheets) with the power of relational databases, without requiring knowledge of relational database administration and relational database languages (e.g., SQL).

Furthermore, in some implementations conversion module 106 is configured to normalize the input data. For example, conversion module 106 may apply one or more business rules (e.g., rules stored in rules store 136) to input data to provide consistency of the input data. For example, conversion module 106 can be configured to normalize spelling, capitalization, punctuation, grammar, etc. In another example, conversion module 106 can be configured to detect that multiple strings (e.g., US, U.S., USA, United States) represent the same data entity, and normalize these strings to a common string when storing the input data in database store 112.

Conversion module 106 can also be configured to convert data stored in database store 112 for consumption by third parties. Such conversions can be driven by business rules in rules data store 136. In some implementations, for example, conversion module 106 may alter the format of data fields in database store 112 to a format required or requested by third party 128.

For example, conversion module 106 may convert data types (e.g., integer to string), convert actual data (e.g., abbreviate or expand data items, perform replacements according to a mapping table), combine data fields, insert new data fields, etc. In additional or alternative implementations, conversion module 106 may convert data in database store 112 to a data structure format requested or required by third party 128 (e.g., XLS/XLSX, comma- or tab-delimited text, XML, HTML, JSON, etc.). As such, conversion module 106 may convert data from a relational data format to a flat data format.

In at least one implementation, API module 108 is configured to provide data in database store 112 to one or more third parties via one or more APIs. For example, API module 108 can work with conversion module 106 to convert data from database store 112 into an appropriate third party format, as described above. In addition, API module 108 can present the API(s) through interface 104. For example, API module 108 may present web-based APIs through a web-based interface. API module can therefore receive API requests from third parties (e.g., API request 130 from third party 128) through interface 104, and provide API responses (e.g., API response 132 to third party 128) through interface 104.

In at least one implementation, API module 108 is also configured to enable a user, such as an administrative user at administrative client 116, to create, update, and manage a set APIs for data transfer with third parties. For example, API module 108 can enable a user to create an API instance for a third party, and configure it for exchange of internal or external data with the third party. As such, API module 108 can enable users great flexibility for communicating their data with third party systems. Furthermore, API module 108 can enable users to share data originally imported as flat data over an API to third parties.

For example, in connection with creating an API instance, API module 108 can enable the user to determine records in database store 112 that will be created, updated, and/or deleted by the API instance. API module 108 can also enable the user to assign appropriate communications headers and footers to allow appropriate communications with the third party system corresponding to the API instance. API module 108 can also enable the user to manipulate the data that is transferred using the API instance, including specifying how many records to update and data ordering.

API module 108 can also enable the user to specify the data transfer type format for use the API instance, such as email, FTP, text file, tab file, web services (e.g., JSON, XML), etc. API module 108 can further enable the user to specify the manner in which the API instance will run and be delivered—such as by providing a Uniform Resource Locator (URL) to run the API instance, or by providing a download link. API module 108 can also enable the user to schedule the API instance to be run on a user-specified interval.

In at least one implementation, UI module 110 can be configured to provide one or more user interfaces to other computer systems. For example, UI module 110 can provide any user interface that is appropriate for use with conversion module 106 or API module 108. In addition, UI module 110 can provide any user interface that is appropriate for interacting with (e.g., viewing, modifying, etc.) data in database store 112, users data in user store 114, and/or rules in rules store 136.

In implementations when interface module 104 comprises a web-based interface, UI module 110 may provide web-based user interfaces (e.g., interfaces based on Hypertext Markup Language (HTML), PHP, JavaScript etc.) for rendering at clients, and receive web-based user input. For example, FIG. 1 depicts that interface module 104 can receive input requests (118, 124) from administrative client 116 and end-user client 122. Correspondingly, UI module 110 can send administrative user interfaces 120 and client user interfaces 126 to administrative client 116 and end-user client 122, respectively.

Administrative user interfaces can include functionality suited for an administrative user at administrative client 116. For example, UI module 110 can present one or more administrative interfaces for importing flat data into middleware system 102. UI module 110 can also present one or more administrative interfaces for editing/manipulating imported data, and one or more administrative interfaces for editing rules in rules store 136. Furthermore, UI module can present one or more administrative interfaces for creating/editing APIs for communication with third parties, one or more administrative interfaces for creating custom forms for end-users, and one or more administrative interfaces for managing users, etc.

Administrative user interfaces for importing flat data into middleware system 102 can enable a user to provide data in a variety of manners. For example, such interfaces can enable a user to upload a file (e.g., XLS/XLSX, TXT, CSV, ODS, etc.). In another example, such interfaces can enable a user to paste in field data (e.g., tab- or comma-delimited text) and submit the pasted-in data to middleware system 102. In another example, such interfaces can enable a user to manually provide data fields and/or values for data fields.

Administrative user interfaces for editing/manipulating imported data can enable a user to edit, add, and delete data in database store 112. For example, such interfaces can enable a user to create and delete data tables, to create and delete data fields, to merge tables and fields, to modify tables and fields, etc. In addition, such interfaces can enable a user to perform searches/replaces on data. For example, such interfaces may enable a user to perform string-based searches and replaces, while limiting the scope of the searches based on identified fields/columns other and/or data that is matched in a search. As such, such user interfaces can provide an administrator data manipulation abilities.

Administrative user interfaces for editing rules can enable a user to create, modify, and delete conversion rules. For example, such interfaces can enable a user to create, modify, and delete rules for converting flat data to relational data, rules for normalizing data, rules for converting data for third-party consumption, etc. Similarly, administrative user interfaces for user interfaces for building and editing APIs can enable a user to perform any of the functionality described above in connection with API module 108 for creating, editing, and deleting API instances.

Administrative user interfaces for creating custom forms for end-users can enable an administrator to create data entry forms that are customized based on one or more user attributes. For example, an organization may have data related to varying departments (e.g., marketing, sales, development, etc.). As such, an administrator can create custom forms for different user types (e.g., marketing, sales, etc.), or even for specific users, that provide input options only for fields that are of interest to the user type or specific user. In some implementations, custom forms can limit the type of data that can be input into the fields by using GUI elements such as drop-downs and bullet lists, or matching mechanisms such as blacklist, whitelists, etc. In some implementations, administrative user interfaces can enable a user to create rules for the automatic generation of custom forms based on user attributes.

When creating custom forms, some implementations include creating/providing a custom URL for retrieving the form. The URL can then be provided to a user for data entry. Thus, upon receipt of the URL, the user can open the custom form by navigating to the URL and obtain the custom form for data entry.

Administrative user interfaces for managing users can enable an administrator to create, modify, and delete user information stored in user store 114. In some implementations, such interfaces may enable an administrator to assign user types to end-users (e.g., marketing, sales), which can be used for determining a type of custom form to present to the end-user.

Client user interfaces can include functionality suited for an end-user at end-user client 122. For example, UI module 110 can present one or more client interfaces for importing flat data into middleware system 102, one or more client interfaces for editing/manipulating imported data, etc. Such interfaces may be similar to the user interfaces described above in connection with administrative interfaces, but may include more limited options and/or options specifically suited for a user type.

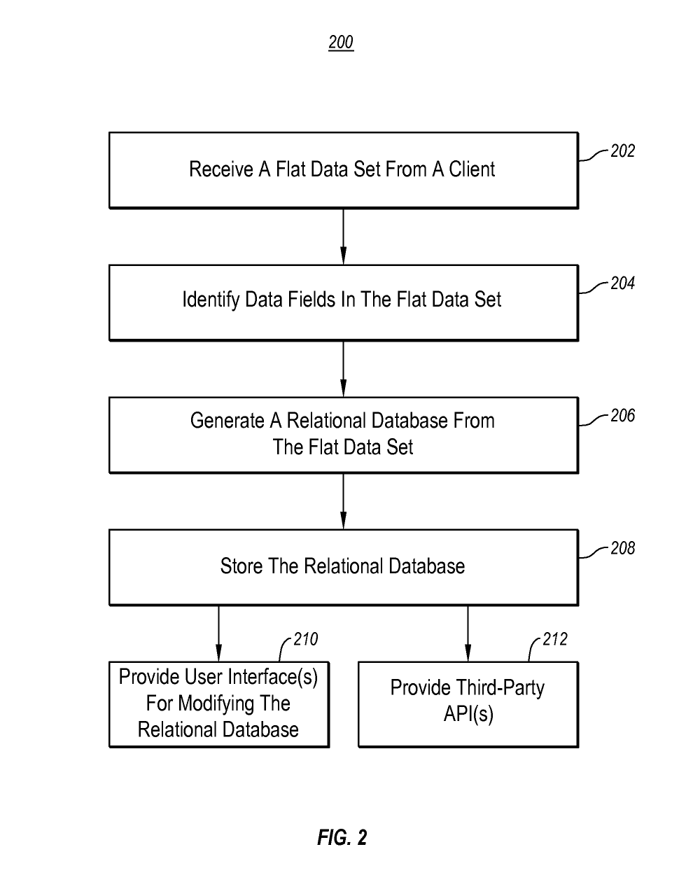

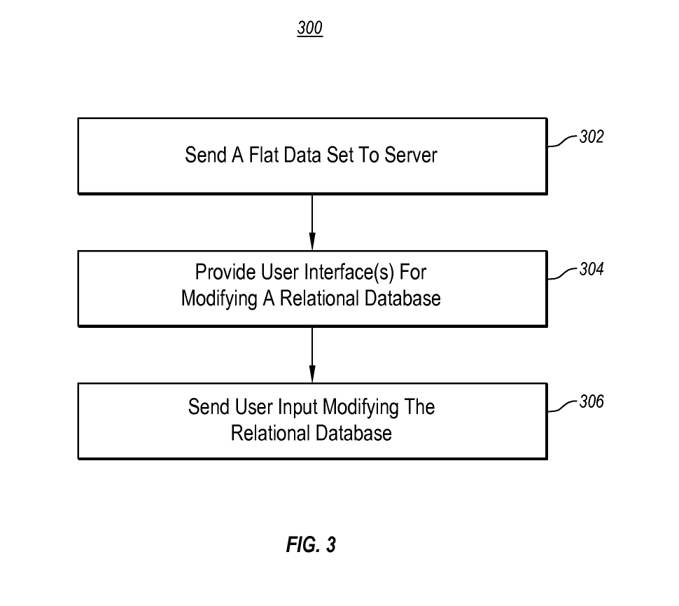

In addition to the foregoing, implementations of the present invention can also be described in terms of flowcharts comprising one or more acts in a method for accomplishing a particular result. Along these lines, FIGS. 2 and 3 illustrate flowcharts of computerized methods for automatically generating a relational database. For example, FIG. 2 illustrates a flowchart of acts in a method for automatically generating a relational database based on flat data received from a client computer system. FIG. 3 illustrates a flowchart of acts in a method for automatically generating a database based on flat data sent by a user. The acts of FIGS. 2 and 3 are described below with respect to the components and diagrams shown in FIG. 1.

For example, FIG. 2 shows that a method 200 from the perspective of middleware system 102 for automatically generating a relational database based on flat data received from a client computer system can comprise an act 202 of receiving a flat data set from a client. Act 202 can include receiving, at a web-based interface, a data set from a client computer system, wherein the data set comprises flat data having one or more data fields. For example, middleware system 102 can receive input 118 from administrative client 116 or input 124 from end-user client 122. Input 118, 116 can include flat data such as a spreadsheet, tab- or comma- separated values, etc., that includes one or more data fields. Input 118, 116 can comprise uploaded files, pasted data, manually-entered data, etc.

FIG. 2 also shows that method 200 can comprise an act 204 of identifying data fields in the flat data set. Act 204 can include, based on receiving the data set, automatically identifying the one or more data fields from the flat data. For example, conversion module 106 can identify any data fields in the received flat data input 118, 116.

FIG. 2 also shows that method 200 can comprise an act 206 of generating a relational database from the flat data set. Act 206 can include, based on receiving the data set, automatically generating a relational database comprising each identified data field from the flat data. For example, based on the identified data fields in the flat data, conversion module 106 can identify data types and identify relationships between data fields, and then generate relational data tables based on the identified data fields. Conversion module 106 may also generate unique identifiers for identified data fields and/or generated data tables, and then form data relationships through the generated unique identifiers. Conversion module 106 can also normalize the input data. For example, conversion module 106 may apply one or more business rules from rules store 136 to the input data to provide data consistency.

FIG. 2 also shows that method 200 can comprise an act 208 of storing the relational database. Act 208 can include storing the relational database for subsequent modification, management, and/or retrieval by one or more users at one or more client computer systems. For example, conversion module 106 can store the generated relational data tables in a data structure in database store 112.

FIG. 2 also shows that method 200 can comprise an act 210 of providing user interface(s) for modifying the relational database. Act 210 can include providing, through the web-based interface, one or more user options at the client computer system for modifying the identified data fields of the relational database. For example, UI module 110 can provide one or more administrative or client user interfaces that enable a user to create, edit, and modify data in the data structure that is stored in database store 112. Such user interfaces can enable users to create custom forms; to display and provide data input into custom forms; to create, edit, and modify data fields and tables; etc.

FIG. 2 also shows that method 200 can comprise an act 212 of providing third-party API(s). Act 212 can include providing, through the web-based interface, one or more APIs configured to provide one or more of the identified data fields of the relational database to one or more third parties. For example, API module 108 can present an API to third party 128. As such, API module 108 can enable middleware system 102 to receive API request 130 from third party 128 and/or enable middleware system 102 to provide API response 132 to third party 128. One will appreciate that APIs can provide data from database store 112 to third party 128 in any format that is appropriate for third party 128.

In addition to the foregoing, FIG. 3 shows that a method 300 from the perspective of a client (e.g., administrative client 116, end-user client 122) for automatically generating a database based on flat data sent by a user can comprise an act 302 of sending a flat data set to a server. Act 302 can include sending user input of a data set to a server computer system, wherein the data set comprises flat data having one or more fields, wherein the user input causes the server computer system to automatically generate a relational database from the one or more fields of the flat data. For example, end-user client 122 can send input 124, or administrative client 116 can send input 118, to middleware system 102. The input can include flat data having data fields. Upon receipt of the input, middleware system 102 can use conversion module 106 to convert the flat data input to relational data, and store the relational data in database store 112. Conversion module 106 can also normalize the input data.

FIG. 3 also shows that method 300 can comprise an act 304 of providing user interface(s) for modifying a relational database. Act 304 can include displaying a web-based user interface received from the server computer system, wherein the web-based user interface identifies the one or more fields from the flat data as part of the relational database. For example, UI module 110 can provide one or more administrative or client user interfaces that enable a user to create, edit, and modify data fields and tables, etc. In some implementations, UI module 110 can provide a custom form that is tailored for a specific user, including only a subset of the data fields that are of interest to the user.

Act 304 can also include displaying through the web-based user interface one or more user options for modifying the one or more fields of the relational database. For example, one or more user interfaces provided by UI module 110 can enable a user to input data into the data fields; to create, modify, or delete available data fields; to merge data fields; etc.

FIG. 3 also shows that method 300 can comprise an act 306 of sending user input modifying the relational database. Act 306 can include sending to the server computer system one or more user inputs modifying the one or more fields of the relational database. For example administrative client 116 can provide input 118 modifying relational data or data fields, and/or end-user client 122 can provide input 124 modifying relational data or data fields.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

Embodiments of the present invention may comprise or utilize a special-purpose or general-purpose computer system that includes computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical storage media that store computer-executable instructions and/or data structures. Physical storage media includes recordable-type storage devices, such as RAM, ROM, EEPROM, solid state drives (“SSDs”), flash memory, phase-change memory (“PCM”), optical disk storage, magnetic disk storage or other magnetic storage devices, or any other physical storage medium which can be used to store program code in the form of computer-executable instructions or data structures, and which can be accessed by a general-purpose or special-purpose computer system.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud computing model can be composed of various characteristics, such as on-demand self-service, broad network access, resource pooling, rapid elasticity, measured service, and so forth. A cloud computing model may also come in the form of various service models such as, for example, Software as a Service (“SaaS”), Platform as a Service (“PaaS”), and Infrastructure as a Service (“IaaS”). The cloud computing model may also be deployed using different deployment models such as private cloud, community cloud, public cloud, hybrid cloud, and so forth.

Some embodiments, such as a cloud computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. At a server computer system in a computerized environment in which one or more users manage data, a computerized method for automatically generating a relational database based on flat data received from a client computer system, the method comprising:
receiving, at a web-based interface, a data set from a client computer system, wherein the data set comprises flat data having one or more data fields;
based on receiving the data set:
automatically identifying the one or more data fields from the flat data; and
automatically generating a relational database comprising each identified data field from the flat data;
storing the relational database for subsequent modification, management, and/or retrieval by one or more users at one or more client computer systems;
providing, through the web-based interface, one or more user options at the client computer system for modifying the identified data fields of the relational database; and
providing, through the web-based interface, one or more application programming interfaces (APIs) configured to provide one or more of the identified data fields of the relational database to one or more third parties.

2. The method as recited in claim 1, wherein receiving the data set through the web-based interface comprises receiving the data set from an end-user.

3. The method as recited in claim 1, wherein receiving the data set through the web-based interface comprises receiving the data set from an administrative user.

4. The method as recited in claim 1, wherein the web-based interface comprises a web-based administrative user interface configured for access by a user having administrative credentials, the method further comprising:
receiving administrative user input at the web-based administrative user interface, the administrative user input specifying one or more limitations on use of the relational database by an end-user.

5. The method as recited in claim 4, further comprising:
sending, to the client computer system, information configured to enable the client computer system to implement a web-based client user interface at the client computer system, the web-based client user interface being based on the specified one or more limitations.

6. The method as recited in claim 1, wherein providing one or more user options at the client computer system for modifying the identified data fields of the relational database comprises generating a custom form for a particular user, the custom form providing one or more user-input fields corresponding to a subset of the data fields of the relational database that are of interest to the particular user.

7. The method as recited in claim 6, further comprising:
generating a custom uniform resource locator (URL) for the custom form; and
providing the custom URL to the particular user.

8. The method as recited in claim 1, further comprising:
providing, through the web-based interface, an API builder configured to generate one or more APIs for providing data fields of the relational database to one or more third parties, the API builder generating the one or more APIs based on user input received through the web-based interface.

9. The method as recited in claim 1, wherein providing one or more APIs configured to provide one or more of the identified data fields of the relational database to one or more third parties comprises translating one or more of the identified data fields of the relational database for use by a third party.

10. The method as recited in claim 1, wherein translating one or more of the identified data fields of the relational database for use by the third party comprises modifying one or more of data field format, data field name, or data field content.

11. The method as recited in claim 1, wherein translating one or more of the identified data fields of the relational database for use by the third party comprises flattening relational data into flat data.

12. At a client computer system in a computerized environment in which one or more users manage data, a computerized method for automatically generating a database based on flat data sent by a user, the method comprising:
sending user input of a data set to a server computer system, wherein the data set comprises flat data having one or more fields, wherein the user input causes the server computer system to automatically generate a relational database from the one or more fields of the flat data;
displaying a web-based user interface received from the server computer system, wherein the web-based user interface identifies the one or more fields from the flat data as part of the relational database;
displaying through the web-based user interface one or more user options for modifying the one or more fields of the relational database; and
sending to the server computer system one or more user inputs modifying the one or more fields of the relational database.

13. The method as recited in claim 12, further comprising:
sending user input including a user identifier of a particular user to the server computer system; and
receiving a customized form from the server computer system, the customized form providing one or more user-input fields corresponding to a subset of the data fields of the relational database that are of interest to the particular user.

14. The method as recited in claim 13, wherein receiving a customized form from the server computer system comprises receiving a customized URL.

15. The method as recited in claim 13, further comprising:
sending a flat file as user input for the one or more user-input fields.

16. The method as recited in claim 12, further comprising:
displaying one or more web-based administrative user interfaces for access by a user with administrative credentials;
receiving an administrative user input specifying one or more limitations on use of the relational database by an end-user; and
sending to the server computer system information regarding the one or more specified limitations, causing the server computer system to generate information configured to implement a client user interface based on the one or more specified limitations.

17. The method as recited in claim 12, further comprising:
displaying through the web-based user interface an application programming interface (API) builder configured to receive user input for generating one or more APIs for providing data fields of the relational database to one or more third parties; and
sending user input for generating one or more APIs to the server computer system.

18. The method as recited in claim 17, wherein sending user input for generating one or more APIs to the server computer system comprises sending user input specifying a data type conversion to perform when providing data fields of the relational database to one or more third parties.

19. The method as recited in claim 17, wherein sending user input for generating one or more APIs to the server computer system comprises sending user input specifying a data structure type to use when providing data fields of the relational database to one or more third parties.

20. A computer program product comprising one or more recordable-type computer-readable storage devices having stored thereon computer-executable instructions that, when executed by one or more processors of a computer system, cause the computer system to implement a method of automatically generating a relational database based on one or more flat files received from a client computer system, including the following:
receiving, at a web-based interface, a data set from a client computer system, wherein the data set comprises one or more flat files having one or more data fields;
based on receiving the data set:
automatically identifying the one or more data fields from the one or more flat files; and
automatically generating a relational database comprising each identified data field from the one or more flat files;
providing, through the web-based interface, one or more user options at the client computer system for modifying the identified data fields of the relational database;
providing, through the web-based interface, one or more application programming interfaces (APIs) configured to provide one or more of the identified data fields of the relational database to one or more third parties; and
storing the relational database for subsequent modification, management, and/or retrieval by one or more users at one or more client computer systems.
